(19) United States
(12) Patent Application Publication
(10) Pub. No.: US 2003/0209115 A1
(43) Pub. Date: Nov. 13, 2003

(54) Apparatus and method for positioning tool heads in spaced linear array

(76) Inventors: Arthur P. Burkart, Phillips, WI (US); Carl R. Marschke, Phillips, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/141,458

(22) Filed: May 7, 2002

(51) Int. Cl. B26D 1/24

(52) U.S. Cl. 83/13; 83/425.4; 83/504; 83/508.3

(57) ABSTRACT

A line of tool heads are individually positioned along a track and locked in operative position from a transport position along the track in which each of the tool heads is releasably connected to the next adjacent tool head in the line and the tool head at one end of the line is similarly releasably connected to a drive engine. The engine moves the train of coupled tool heads to an initial position where the first tool head at the end of the train is locked in its operative position and then uncoupled from the train. The remaining tool heads are sequentially positioned, locked and released from the train. The next to last of the tool heads being locked in place and then uncoupled from the engine which runs on the same track, carries the last tool head and is also locked in its final operative position.

### BACKGROUND OF THE INVENTION

The present invention pertains to the positioning of a line of tools or tool-carrying heads in a spaced linear array and, more particularly, to an apparatus and method for sequentially positioning and locking into position a series of tool heads. One particularly useful embodiment is to establish and lock in operating position the rotary tool heads for a slitter/scorer machine used in the conversion of a running paper web.

Slitter/scorer machines are used in the corrugated paperboard industry to slit a running web of corrugated paperboard and to also provide score lines in the web to facilitate subsequent folding in the construction of paperboard boxes and the like. Both slitting and scoring are accomplished by running the corrugated web between pairs of rotatable slitting tools and scoring tools disposed in the path of the web with one tool of each pair located on an opposite side of the web. Respective pairs of slitting tools and/or scoring tools are typically mounted in upper and lower coaxially aligned and laterally spaced groups. In one common type of prior art slitter/scorer machine, each of a plurality of coaxially mounted rotary slitting tools or rotary scoring tools is mounted on its own tool head. A common drive shaft is mounted to extend through the hubs of all coaxially aligned tools of a group and the shaft is driven to concurrently drive all of the tools mounted thereon. The tool heads for each group are slidably mounted on linear ways or tracks that extend parallel to the drive shaft so that each slitting tool or scoring tool may be selectively positioned laterally across the width of the running paperboard web.

In one prior art device, each tool head includes its own servomotor to move the tool head laterally to its selected operating position by means, for example, of a driven pinion operatively engaging a linear rack extending along the track. Thus, in a typical slitter/scorer a plurality of upper and lower slitting head pairs and a plurality of upper and lower scoring head pairs are mounted on four substantially identical support assemblies, each comprising a drive shaft, a linear track, and a positioning rack. In addition, each tool head assembly requires some means to lock the head in its selected operative position. The lockdown apparatus may comprise a separate locking device for each tool head or, alternately, may comprise a locking bar that is disposed parallel to the drive shaft and which is movable into simultaneous locking engagement with each of the tool heads supporting a group of coaxially mounted tools to lock the heads in place.

Other means for selectively positioning a group of coaxially mounted slitting or scoring tools and locking the tools in operative position are also known. In one device, a carriage is mounted to be driven along a track parallel to the tool head drive shaft and to carry with it all of a selected group of slitting or scoring tools for a particular order. The tool group is moved by the carriage to the farthest point on the drive shaft where the first tool is to be operatively positioned, the first tool is released in position, and the carriage is moved in reverse, sequentially depositing each tool head in its selected operative position until the entire group has been set. The carriage includes a complex electro-mechanical arrangement of stops and pusher elements, as well as separate means for locking each tool in operative position. As indicated above, each of these complex positioning and locking devices is required for each of the multiple tool carrying drive shafts in a typical slitter/scorer machine.

### SUMMARY OF THE INVENTION

In accordance with the subject invention, each of a group of aligned tool heads is releasably connected to the next adjacent tool head in the line and the tool head at one end of the line is likewise releasably connected to a drive engine. The engine moves the train of interconnected tool heads to an initial position where the first tool head is first locked in its operative position and then uncoupled from the train. The remaining tool heads are sequentially positioned, locked and released from the train, the next to last being locked in place and then uncoupled from the engine which carries the last tool head. The engine and last tool head then moves to position and locks to the track.

In a basic configuration of the apparatus of the present invention, a track supports the tool heads for movement along the path of the linear array of tool heads, a positioning engine is also supported for movement along the track, the engine being releasably connected to a tool head at one end of the line. A coupling device is provided for each tool head that extends in the direction of the engine and is adapted to extend into coupling engagement with the next adjacent tool head. A coupling operator is mounted in each tool head and is adapted to engage the coupling device of the adjacent tool head positioned in the direction opposite the engine to move said tool head with the engine and the remaining array of heads, and to disengage the coupling device to separate that tool head from the array in an operative position. A drive is provided for moving the engine and tool heads along the track. The coupling device preferably comprises a coupling pin that extends in the direction of the engine and is adapted to be received in a coupling bore in the next adjacent tool head. The coupling operator preferably comprises a piston mounted for reciprocal movement on a line transverse to the track and adapted to engage the coupling pin in the coupling bore in one position of the piston. The coupling operator piston may be further adapted to lock the tool head to the track in another position and to rest in a neutral position therebetween. The engine also includes a coupling bore for receipt of the coupling pin of the next adjacent releasably connected tool head, and a piston to effect the releasable connection. The engine also preferably includes a tool head and the piston is operative to lock the engine to the track.

In accordance with the corresponding method, a line of tool heads is positioned in a spaced linear array utilizing the steps of (1) driving a positioning engine along a track in a path of the linear array, (2) releasably connecting each tool head to the next adjacent tool head and the tool head one end of the line to the engine, (3) providing each tool head and the engine with a coupling device operable to releasably couple each such tool head to the next adjacent tool head in the direction opposite said one end, and (4) operating the coupling devices in response to engine movement and tool head position signals to position and release the tool heads sequentially beginning with the tool head at said opposite end. The method may also include the steps of (1) providing each tool head with a coupling pin extending parallel to the track and a co-axial coupling bore, (2) mounting the tool heads with each respective coupling pin extending in the direction of the engine into the coupling bore of the next adjacent tool head, and (3) mounting a coupling piston in each tool head for reciprocal movement on a line transverse to the track between a coupling position in engagement with the coupling pin of the next adjacent tool head and an uncoupled position releasing the tool head in an operative position.

In another configuration, the apparatus of the present invention for positioning a line of tool heads in a spaced linear array includes a track that supports the tool heads for movement along the path of the linear array, a positioning engine also supported for movement along the track and releasably connected to a tool head at one end of the line of tools heads, a coupling head for each tool head including a coupling pin that extends parallel to the track in the direction of the engine and is adapted to extend into a coupling bore in the next adjacent tool head, a coupling and locking piston mounted in each tool head for reciprocal movement on a line transverse to the track to lock the tool head to the track in an extended position, to engage the coupling pin of the adjacent tool head in the coupling bore in a retracted position, and to rest in a neutral position between the extended and retracted positions, and a drive for moving the engine and tool heads along the track. The engine also includes a coupling bore for receipt of the coupling pin of the releasably connected tool head and a coupling and locking piston that provides the releasable connection to the adjacent tool head and locks the engine to the track.

In a presently preferred embodiment, the track includes opposed parallel track slots, and each of the tool heads has a first edge adapted to slidably engage one track slot and a second edge adapted to slidably engage the other track slot, and the piston is mounted to interrupt the second edge when moved to the extended position to lockingly engage the other track slot. Said other track slot is preferably wedge-shaped and the piston includes a wedge-shaped locking edge that is mounted to move to the extended position through an opening in the second edge of the tool head and into locking engagement in the wedge-shaped slot.

The positioning engine is preferably supported for rolling movement on the track. To this end, the positioning engine includes a pair of spaced wheels in rolling engagement with one track slot and a single wheel positioned between the spaced wheels and in rolling engagement with the other track slot.

In one embodiment, the drive for the engine comprises a lead screw that extends parallel to the track and a lead screw nut on the engine in driving engagement with the lead screw. In another embodiment, the lead screw is driven and the screw nut is fixed to the engine.

A fluid pressure source is operatively connected to the piston to provide the reciprocal piston movement in each tool head. The fluid pressure source preferably comprises a positive pressure source, an atmospheric pressure source and a negative pressure source. A pressure distribution valve applies positive pressure to establish the extended position of the piston and negative pressure to establish the retracted or coupling position of the piston. The pressure distribution valve is also operative to vent the piston to atmosphere to establish the neutral position of the piston.

In accordance with the method of the present invention, a line of tool heads is positioned in a spaced linear array by a method comprising the steps of (1) driving a positioning engine along a track in the path of the linear array, (2) releasably connecting each tool head to the next adjacent tool head and the tool head at one end of the line to the engine, (3) providing each tool head and the engine with a coupling and locking device that is operable to lock each respective tool head and the engine to the track and to releasably couple the next adjacent tool head positioned in the direction opposite said one end, and (4) operating the coupling and locking devices in response to engine movement and tool head position signals to lock and release the tool heads sequentially beginning with the tool head at the end opposite the engine. The method also preferably includes the steps of (1) providing each tool head with a coupling pin that extends parallel to the track and a coaxial coupling bore, (2) mounting the tool heads with each respective coupling pin extending in the direction of the engine and into the coupling bore of the next adjacent tool head, and (3) mounting a coupling and locking piston in each tool head for reciprocal movement on a line transverse to the track between a coupling position in engagement with the coupling pin of the next adjacent tool head with the coupling pin of the next adjacent tool head and a locking position in engagement with the track.

The foregoing method also preferably includes the step of providing the engine with a coupling bore for receipt of the coupling pin of the releasably connected tool head and a coupling and locking piston to effect the releasable connection in a coupling position and to lock the engine to the track in a locking position. The method also includes the steps for each head in sequence of (1) applying a negative fluid pressure to the piston head to effect movement to the coupling position, (2) applying a positive fluid pressure to a head of the piston to effect movement to the locking position, and (3) relieving the pressure on the head to permit the piston to move to a neutral position between said locking and coupling positions.

### BRIEF DESCRIPTION OF THE DRAWINGS

FIG. 1 is an end view of the apparatus of the subject invention as applied to a system for positioning the tool heads in a slitter/scorer machine.

FIG. 2 is a perspective view of the apparatus shown in FIG. 1.

FIG. 3 is an enlarged horizontal section taken on line 3-3 of FIG. 1.

FIGS. 4 and 5 are sectional views similar to FIG. 3 showing the continued sequence of locking and releasing a tool head.

FIG. 6 is a horizontal sectional view of the apparatus after each of the tool heads has been positioned and locked in place.

FIG. 7 is an enlarged vertical sectional detail taken on line 7-7 of FIG. 5.

FIG. 8 is an enlarged vertical sectional detail taken on line 8-8 of FIG. 5.

FIG. 9 is an enlarged vertical sectional detail taken on line 9-9 of FIG. 5.

### DETAILED DESCRIPTION OF THE PREFERRED EMBODIMENT

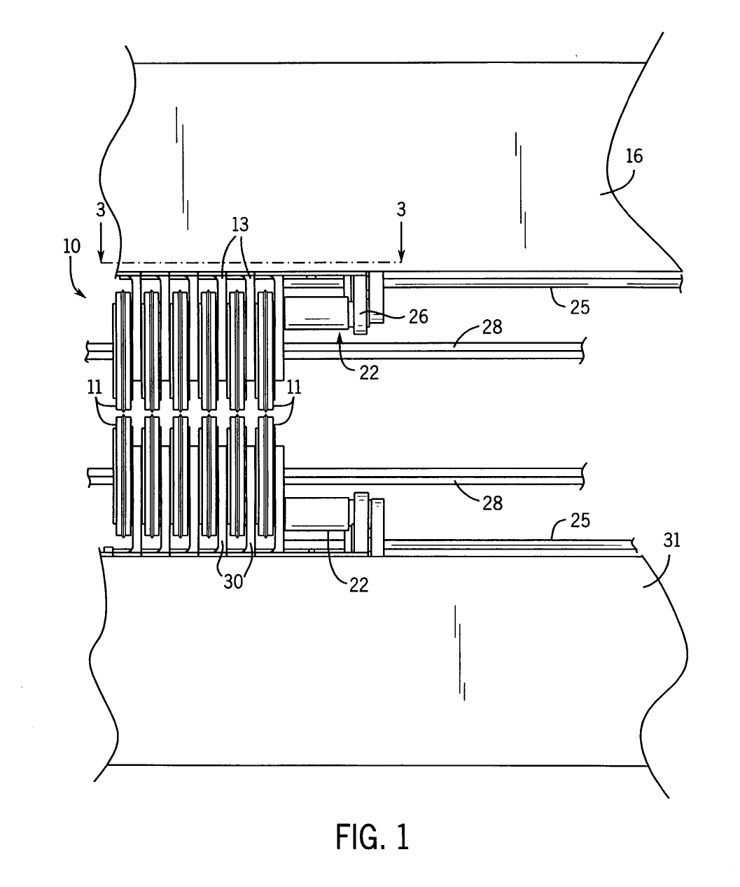

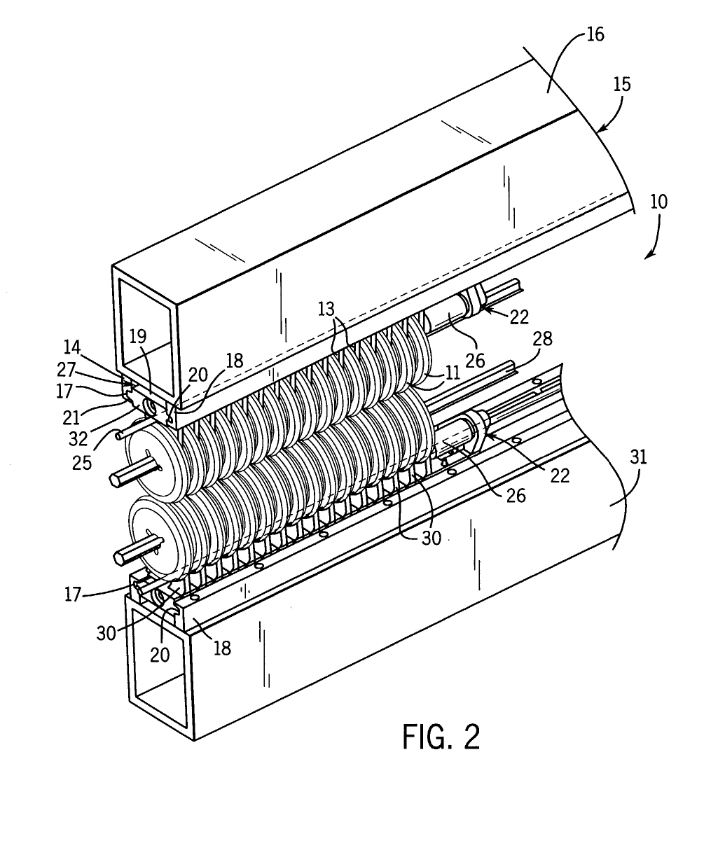

In FIGS. 1 and 2, the apparatus of the subject invention is shown as applied to a system for positioning the scoring tool heads of a slitter/scorer machine 10. Each scoring tool 11 is individually rotatably mounted on its own tool head 13. The scoring tools 11 are operated in pairs comprising an upper scoring tool and a lower scoring tool, with each operative pair of upper and lower tools moved from a standby position shown in FIG. 1 to an operative position across the width of a running paperboard web (not shown) between the upper and lower pairs of tools 11 in a direction perpendicular to the plane of FIG. 1.

Each group of upper tool heads 13 is mounted in a linear array and movable along an upper track 14 that is supported on the underside of a main cross member 15 in the form of a box beam 16. The upper track 14 is defined by a pair of opposed parallel track slots 17, each formed in a horizontally extending track member 18 depending downwardly from the underside of the box beam 16. Each of the track slots 17 is preferably wedge-shaped and includes a flat vertical end face 20. Each upper tool head 13 includes a track-engaging body 19 having oppositely extending outer edges 21 adapted to slidably engage the track slots 17, enabling the tool head to move along the track supported in the slots 17.

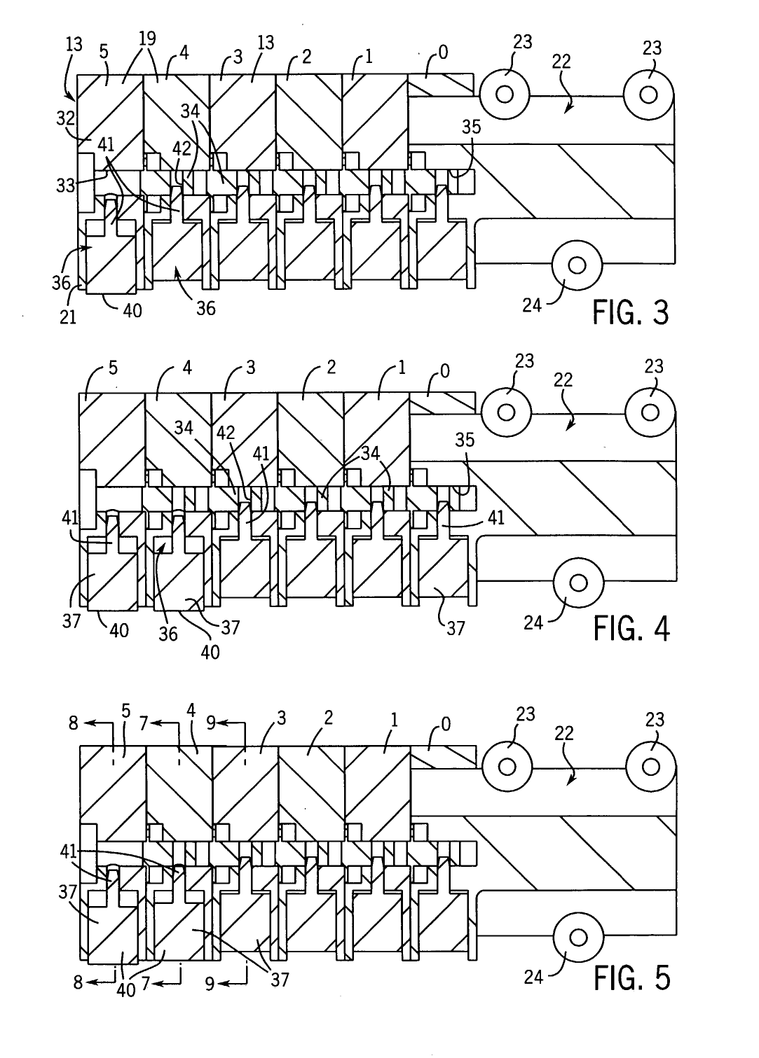

A tool head positioning engine 22 is positioned at one end of the line of upper tool heads 13 and is supported for movement along the upper track 14. Preferably, the engine 22 also carries a tool head 13. As shown in FIG. 3, the engine 22 is supported for rolling movement along the track 14 by a pair of spaced wheels 23 in engagement with one track slot 17 and an opposite single wheel 24 in engagement with the opposite track slot 17. The single wheel 24 is spring biased into engagement with the track slot 17 in which it travels, thereby forcing the opposite spaced wheels 23 into engagement with the end face 20 of the slot in which they travel. The engine 22 is also operatively attached to an upper lead screw 25 that extends parallel to the track 14 and across the full width of the slitter/scorer 10. An electric motor/reducer 26 drives a screw nut or similar device (not shown) in driving engagement with the lead screw 25 to move the engine (and attached train of tool heads 13) along the track 14. Alternately, the lead screw 25 may be driven and the engine 22 provided with a screw nut that is driven by the lead screw to effect movement of the engine along the track. Electric or pneumatic power to drive the motor 26 may be supplied by cabling or hoses extending along an open passage 27 defined by the underside of the box beam 16 and the track members 18 or in the space between the axes of the tools. A similar open passage 27 is provided between the top face of lower box beam 31 and track member 18.

Preferably the scoring tools 11 rotatably mounted on the lower tool heads 30 are driven by a common drive shaft 28 that extends in the cross machine direction parallel to the lead screw 25 and track 14. As the tool heads are moved along the track 14 by the positioning engine 22, the scoring tools 11 slide along the drive shaft 28. The drive shaft is driven from one side of the slitter/scorer machine 10 in a manner well known in the art and may have a hexagonal cross section, as shown, to enable it to impart driving rotation to the scoring tools 11 mounted thereon.

The construction, mounting, and operation of the lower tool heads 30 is the same as described above for the upper tool heads 13. Lower tool heads 30 are supported on a lower box beam 31, which may be a common box beam for all lower tools, in an orientation inverted from the upper tool heads 13, but otherwise are similar and, therefore, the same reference numbers are applied to identify identical elements of the lower tool head assembly.

Referring to FIG. 3, the track-engaging body 19 of each tool head 13 is provided with a bore 33 that axis of which extend parallel to the track 14. The bore 33 is open on the face of the body away from the engine and closed by one end of a coupling pin 34 mounted on the opposite face of the tool head body 19 and extending coaxially with respect to the axis of the bore 33. When the tool heads 13 are stacked in a standby position, as shown in FIGS. 1-3, the coupling pin 34 on each tool head extends into the bore 33 of the next adjacent tool head in the direction of the positioning engine 22. For the tool head immediately adjacent the engine 22, the coupling pin 34 extends into a similar coupling bore 35 in the body of the engine. Also mounted in the body 19 of each tool head 13 is a laterally reciprocable piston 36, the controlled movement of which on a line transverse to the track 14 serves to engage the coupling pin 34 of the adjacent tool head in a retracted position to couple the tool heads together or to lock the tool head to the track in an extended position. In a neutral position of the piston, between the retracted and extended positions, the tool head is neither coupled nor locked.

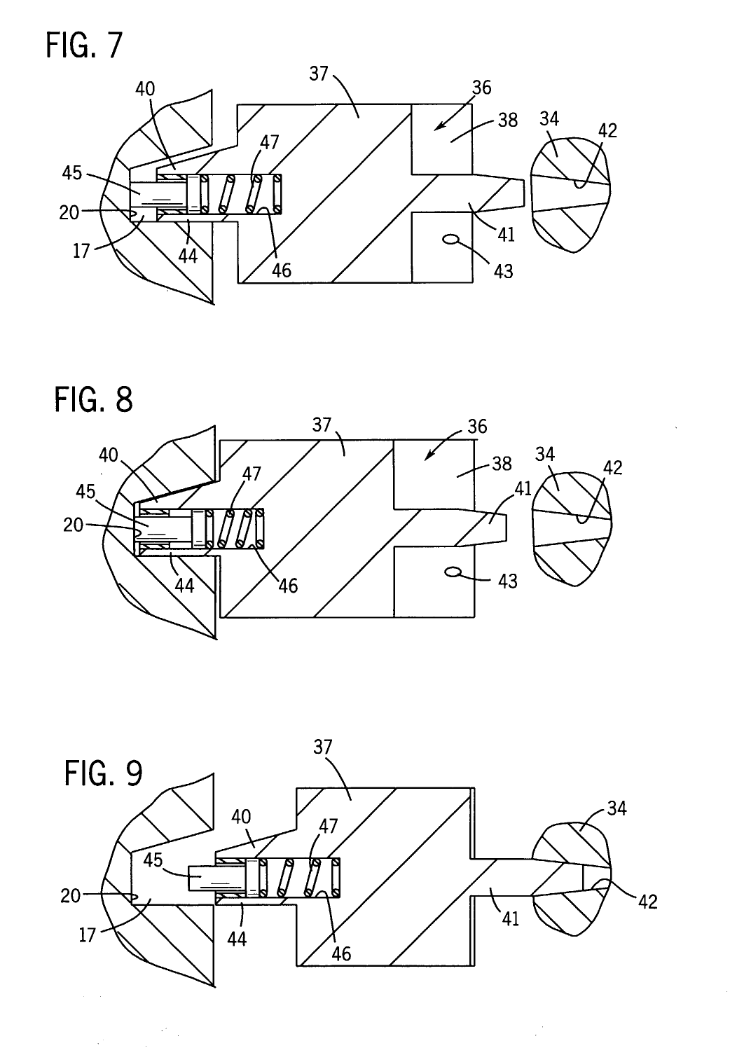

Referring also to FIG. 7, the piston head 37 is mounted for a relatively short stroke in piston bore 38. The outer face of the piston head 37 is provided with a wedge-shaped locking edge 40 which is adapted to pass through an opening in one of the side edges 21 in the body 19 of the tool head, in the FIG. 8 extended position, to engage the track slot 17 and lock the tool head in position on the track. When the piston head 37 is moved in the opposite lateral direction, to the retracted position shown in FIG. 9, a laterally extending keeper pin 41 on the inside face of the piston enters a cross bore 42 in the coupling pin 34 of the next adjacent tool head to couple the two tool heads 13 together.

A simplified system for supplying fluid pressure to operate the piston 36 requires only a single fluid pressure line for each tool head. The locking and coupling functions of the piston 36 are provided by applying a positive air pressure or a negative air pressure to the piston 36 via a pressure port 43 in the cylinder wall 38. Positive pressure applied to the piston cylinder 38 will move the piston to the FIG. 8 extended locking position and a negative fluid pressure (vacuum) applied to the cylinder will cause the piston head to retract to the FIG. 9 position moving the keeper pin 41 into the coupling pin cross bore 42. If the piston cylinder 38 is vented to atmosphere after being in the locked position, the piston 36 will move to the neutral position of FIG. 7. To assure movement of the piston from the locked FIG. 8 position to the neutral FIG. 7 position, a spring-biased release mechanism 44 is provided in the locking edge 40 of the piston head. When the piston head 37 moves to the locked position (FIG. 8) a release button 45 seated in the outer end of a blind bore 46 moves axially inwardly to compress a coil spring 47. When the cylinder is subsequently vented to atmosphere, the spring 47 will cause the release button in engagement with the end face 20 of the track slot 17 to move the piston out of locking engagement with the track and into the neutral FIG. 7 position.

In lieu of a pneumatic operating system for the locking and coupling functions of the pistons 36, operating piston movement could be provided by permanent magnet solenoids. Operating current in this embodiment would be supplied to the solenoids by cabling located in the open passages 27 described above. Reciprocal piston movement is effected by reversing the current to the solenoids. This construction, of course, eliminates all of the pneumatic lines.

The operation of the apparatus will now be described with reference to FIGS. 3-6 in which the positioning engine 22 and the tool head locking system operate to position five tool heads 13 (or six tool heads if the engine also carries one as in the preferred embodiment). The engine 22 and attached train of tool heads 13 is positioned by driving the engine 22 along the track 14 so that the tool head farthest from the engine, designated as tool head No. 5, is in its final operative position. Its companion lower tool head 30 will also have been moved to the same operative position as part of a train of lower tool heads 30 driven by the positioning engine 22 operating along the lower box beam 31.

With the train in the FIG. 3 position, positive air pressure is applied to the No. 5 piston 36, causing the piston to extend and lock the tool head 13 to the track 14. The remaining tool head pistons all have a vacuum applied to their respective cylinders so that the entire train is coupled. Thus, the active tool is locked to the frame prior to loss of positive coupling to the positioning engine. In this regard, it should be noted that the engine is also equipped with a piston 36 that operates in the same manner as the tool head pistons, serving to lock the engine to the track in an extended piston position and to couple the engine to the next adjacent tool head 13 in the retracted position (shown in FIG. 3).

Referring now to FIG. 4, with tool head No. 5 still locked to the track 14, a positive pressure is applied to the piston 36 of the next adjacent tool head No. 4. This causes the keeper pin 41 on the No. 4 piston head to be withdrawn from the cross bore 41 in the coupling pin 34 of the No. 5 head, thereby uncoupling tool head No. 5 from the train. It is an important and distinguishing feature of the present invention that a tool head, such as tool head No. 5, is securely locked in operative position before it is released from the train. This provides better accuracy in tool head positioning than prior art systems that lose contact with the positioning mechanism prior to be locked in place.

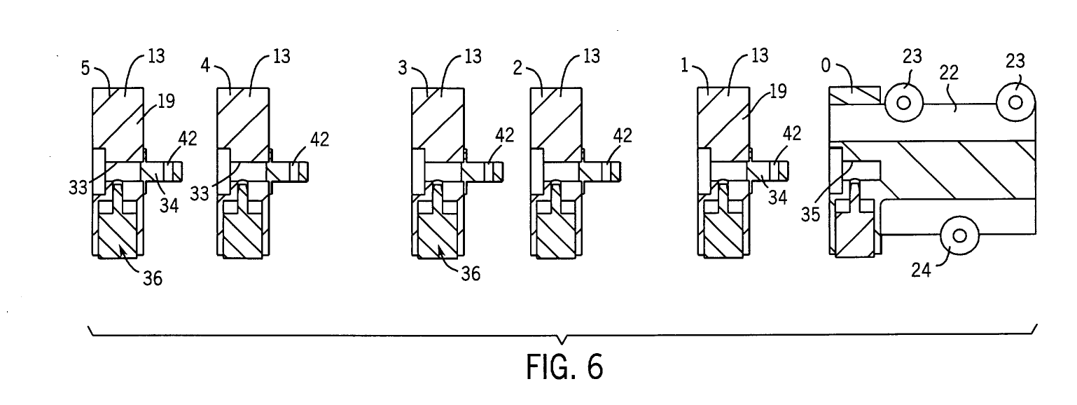

In FIG. 5, the cylinder 38 of the No. 4 tool head has been vented to atmosphere, causing the piston head 37 to move from the locked (FIG. 8) position to the neutral (FIG. 7) position. In this position, the coupling pin 34 of the No. 5 tool head remains uncoupled from the No. 4 tool head, allowing the engine 22 with the four remaining tool heads to be moved away from the No. 5 tool head until the No. 4 tool head is in its desired operative position. The cylinder 38 for the piston of the No. 4 tool head is then supplied with a positive air pressure causing the piston head to move into the locked position in engagement with the track slot 17 (FIG. 8). Once locked in position, the No. 4 tool head is uncoupled from the train by applying a positive air pressure to the cylinder of the piston in the No. 3 tool head causing it to move to the locked position and withdrawing the keeper pin 41 from the cross bore 42 in the coupling pin 34 of the No. 4 tool head. With the No. 4 tool head now locked securely in position, the cylinder 38 of the No. 3 piston is vented to atmosphere, causing the piston to move to the neutral position permitting the engine 22 and remaining three tool heads to move along the track until the No. 3 tool head is in its desired operative position. The process is repeated until all five tool heads are in their selected operative positions, as shown in FIG. 6 and the last (No. 1) tool head has been uncoupled from the engine and the engine, carrying the No. 0 tool is moved laterally to the final tool position. In their final operating positions, all tool heads 13 have positive air pressure applied to the pistons to lock them securely to the track.

When it is desired to effect an order change, all upper tools are moved vertically out of engagement with the web and all of the cylinders 38 in the tool heads 13 and in the positioning engine 22 are vented to atmosphere causing the pistons to unlock and move to a neutral position. The engine is then driven in the reverse direction along the track 14, first causing the coupling pin 34 of the No. 1 tool head to be received in the engine coupling bore 35. The coupling pins 32 of the remaining tool heads are sequentially received in the coupling bores 33 of the next tool head as it moves into contact while being driven by the engine 22. All the tool heads are eventually collected and moved back to the FIG. 1 position from which they are reset to the new order position in the same manner described above.

The coupling devices described above and utilized to releasably connect the train of tool heads and the first tool head to the engine may be of various constructions. In addition to the arrangement of coupling pins 34 and fluid actuated keeper pins 41, the coupling devices could comprise electromagnetic couplings. Other coupling and locking devices, operated by fluid pressure, electromagnetic or mechanical means could also be used. Although, in the preferred embodiment, the system and method of the present invention contemplate sequential positioning and locking of the tool heads, it is intended that in a broader aspect the invention provides a unique tool head positioning system in which the locking function would be provided independently and by utilizing an entirely different mechanism. For example, each of the tool heads could be sequentially positioned in the manner described above and an independent common locking device used to simultaneously lock all tool heads in their selected positions. Such a common locking device is disclosed, for example, in U.S. Pat. Nos. 4,627,214 and 5,316,109. In addition, each of the tool heads may be provided with a separate locking device that operates completely independently of the tool head coupling arrangement. For example, a solenoid-operated or other electromagnetic arrangement could be utilized to lock each tool head to the track in the operative position of the tool head.

We claim:

1. An apparatus for positioning a line of tool heads in a spaced linear array, the apparatus comprising:
a track supporting the tool heads for movement along the path of the linear array;
a positioning engine supported for movement along the track, the engine releasably connected to a tool head at one end of the line;
a coupling device for each tool head extending in the direction of the engine and adapted to extend into coupling engagement with the next adjacent tool head;
a coupling operator mounted in each tool head and adapted to engage the coupling device of the adjacent tool head positioned in the direction opposite the engine to move said tool head with the engine and the remaining array of tool heads, and to disengage the coupling device to separate said tool head from the array in an operative position; and,
a drive for moving the engine and tool heads along the track.

2. The apparatus as set forth in claim 1 wherein said coupling device comprises a coupling pin extending in the direction of the engine and adapted to be received in a coupling bore in said next adjacent tool head.

3. The apparatus as set forth in claim 2 wherein said coupling operator comprises a piston mounted for reciprocal movement on a line transverse to the track to engage the coupling pin in the coupling bore in one position of the piston.

4. The apparatus as set forth in claim 3 wherein the coupling operator piston is further adapted to lock the tool head to the track in another position and to rest in a neutral position therebetween.

5. The apparatus as set forth in claim 4 wherein said engine includes a coupling bore for receipt of the coupling pin of the adjacent releasably connected tool head, and a piston to effect the releasable connection.

6. The apparatus as set forth in claim 5 wherein said engine includes a tool head and said piston is operative to lock the engine to the track.

7. A method for positioning a line of tool heads in a spaced linear array, comprising the steps of:
(1) driving a positioning engine along a track in the path of the linear array;
(2) releasably connecting each tool head to the next adjacent tool head and the tool head at one end of the line to the engine;
(3) providing each tool head and the engine with a coupling device operable releasably couple each such tool head to the next adjacent tool head in the direction opposite said one end; and,
(4) operating the coupling devices in response to engine movement and tool head position signals to position and release the tool heads sequentially beginning with the tool head at said opposite end.

8. The method as set forth in claim 7 comprising the steps of:
(1) providing each tool head with a coupling pin extending parallel to the track and a coaxial coupling bore;
(2) mounting the tool heads with each respective coupling pin extending in the direction of the engine into the coupling bore of the next adjacent tool head; and,
(3) mounting a coupling piston in each tool head for reciprocal movement on a line transverse to the track between a coupling position in engagement with the coupling pin of the next adjacent tool head and an uncoupled position releasing the tool head in an operative position.

9. The method as set forth in claim 7 including the step of providing the engine with a coupling bore for receipt of the coupling pin of the releasably connected tool head and a coupling piston to effect the releasable connection in a coupling position.

10. The method as set forth in claim 9 including the step of providing the engine with a tool head.

11. The method as set forth in claim 10 including the step of: operating the piston of the tool head in the operative position to lock said tool head to the track.

12. The method as set forth in claim 11 wherein said releasing step is performed after the tool head is locked to the track.

13. An apparatus for positioning a line of tool heads, the tool heads being distributed in a spaced linear array, the apparatus comprising:
a track supporting the tool heads for movement along the path of the linear array;
a positioning engine supported for movement along the track, the engine releasably connected to a tool head at one end of the line;
a coupling device for each tool head including a coupling pin extending parallel to the track in the direction of the engine and adapted to extend into a coupling bore in the next adjacent tool head;
a coupling and locking piston mounted in each tool head for reciprocal movement on a line transverse to the track and adapted to lock the tool head to the track in an extended position, to engage the coupling pin of the adjacent tool head in the coupling bore in a retracted position, and to rest in a neutral position between said extended and retracted positions; and,
a drive for moving the engine and tool heads along the track.

14. The apparatus as set forth in claim 13 wherein said engine includes a coupling bore for receipt of the coupling pin of the releasably connected tool head and a coupling and locking piston to effect the releasable connection and to lock the engine to the track.

15. The apparatus as set forth in claim 14 wherein said engine includes a tool head.

16. The apparatus as set forth in claim 13 wherein said track includes opposed parallel track slots, each of said tool heads having a first edge adapted to slidably engage one track slot and a second edge adapted to slidably engage the other track slot, said piston mounted to pass through said second edge when moved to the extended position to lockingly engage said other slot.

17. The apparatus as set forth in claim 16 wherein said other track slot is wedge-shaped and said piston includes a wedge-shaped locking edge mounted to move to the extended position through an opening in said second edge and into locking engagement with said wedge shaped lot.

18. The apparatus as set forth in claim 16 wherein said positioning engine is supported for rolling movement on the track.

19. The apparatus as set forth in claim 18 wherein said positioning engine includes a pair of spaced wheels in rolling engagement with one track slot and a single wheel between said spaced wheels in rolling engagement with the other track slot.

20. The apparatus as set forth in claim 13 wherein said drive comprises a lead screw extending parallel to the track and a lead screw nut on the engine in driving engagement with the lead screw.

21. The apparatus as set forth in claim 20 wherein said lead screw is driven and said screw nut is fixed to the engine.

22. The apparatus as set forth in claim 20 wherein said screw nut is driven and said lead screw is fixed.

23. The apparatus as set forth in claim 13 including a power source operatively connected to said piston to provide the reciprocal piston movement.

24. The apparatus as set forth in claim 23 wherein the power source comprises fluid pressure and said fluid pressure source includes a positive pressure source and a negative pressure source.

25. The apparatus as set forth in claim 24 including a pressure distribution valve operative to apply positive pressure to establish the extended position of the piston and negative pressure to establish the retracted position of the piston.

26. The apparatus as set forth in claim 25 wherein said pressure distribution valve is operative to vent said piston to atmosphere to establish the neutral position.

27. The apparatus as set forth in claim 23 wherein the power source comprises an electric solenoid for each piston.

28. A method of position a line of tool heads in a spaced linear array, comprising the steps of:
(1) driving a positioning engine along a track in the path of the linear array;
(2) releasably connecting each tool head to the next adjacent tool head and the tool head at one end of the line to the engine;
(3) providing each tool head and the engine with a coupling and locking device operable to lock each respective tool head and the engine to the track and to releasably couple the next adjacent tool head in the direction opposite said one end; and,
(4) operating the coupling and locking devices in response to engine movement and tool head position signals to lock and release the tool heads sequentially beginning with the tool head at said opposite end.

29. The method as set forth in claim 28 comprising the steps of:
(1) providing each tool head with a coupling pin extending parallel to the track and a coaxial coupling bore;
(2) mounting the tool heads with each respective coupling pin extending in the direction of the engine into the coupling bore of the next adjacent tool head; and,
(3) mounting a coupling and locking piston in each tool head for reciprocal movement on a line transverse to the track between a coupling position in engagement with the coupling pin of the next adjacent tool head and a locking position in engagement with the track.

30. The method as set forth in claim 29 including the step of providing the engine with a coupling bore for receipt of the coupling pin of the releasably connected tool head and a coupling and locking piston to effect the releasable connection in a coupling position and to lock the engine to the track in a locking position

31. The method as set forth in claim 30 including the steps of:
(1) applying a positive fluid pressure to a head of the piston to effect movement to the locking position;
(2) applying a negative fluid pressure to the piston head to effect movement to the coupling position; and,
(3) relieving the pressure on the head to permit the piston to move to a neutral position between said locking and coupling positions.

32. A method for positioning a line of tool heads in a spaced linear array comprising the steps of:
(1) supporting the tool heads for movement along a track in the path of the linear array;
(2) mounting a positioning engine for movement along the track;
(3) releasably connecting the engine to the tool head at one end of the line;
(4) providing a coupling device for each tool head including a coupling pin extending parallel to the track in the direction of the engine and into a coupling bore in the next adjacent tool head;
(5) mounting a coupling and locking piston in each tool head for reciprocal movement on a line transverse to the track and adapted to lock the tool head to the track in an extended position, to engage the coupling pin of the adjacent tool head in the coupling bore in a retracted position, and to rest in a neutral position between said extended and retracted positions;
(6) driving the engine and tool heads along the track;
(7) applying a fluid pressure to the piston to provide the reciprocal piston movement; and,
(8) directing the fluid pressure in response to tool head position signals and engine movement to sequentially position and lock the tool heads in said spaced linear array.

33. The method as set forth in claim 32 including the step of providing said engine with a coupling bore for receipt of the coupling pin of the releasably connected tool head and a coupling and locking piston to effect the releasable connection and to lock the engine to the track.

34. The method as set forth in claim 33 including the step of providing the engine with a tool head.

35. An apparatus for positioning a line of tool heads in a spaced linear array, comprising:
a track supporting the tool heads for movement along the path of the linear array;
a positioning engine supported for movement along the track, the engine releasably connected to a tool head at one end of the line;
a coupling device for each tool head including a coupling pin extending parallel to the track in the direction of the engine and adapted to extend into a coupling bore in the next adjacent tool head;
a coupling and locking piston mounted in each tool head for reciprocal movement on a line transverse to the track and adapted to lock the tool head to the track in an extended position, to engage the coupling pin of the adjacent tool head in the coupling bore in a retracted position, and to rest in a neutral position between said extended and retracted positions; and,
a drive for moving the engine and tool heads along the track;
a fluid pressure source operatively connected to the piston to provide the reciprocal piston movement; and,
a fluid pressure distribution valve responsive to tool head position signals and engine movement to sequentially position and lock the tool heads in said spaced linear array.

36. The apparatus as set forth in claim 35 wherein said engine includes a coupling bore for receipt of the coupling pin of the releasably connected tool head and a coupling and locking piston to effect the releasable connection and to lock the engine to the track.

37. The apparatus as set forth in claim 35 wherein said tool heads carry tools for a slitter/scorer machine, and further comprising:
an upper cross beam extending over and transverse to a running web to be slit, said beam supporting an upper track carrying a first line of tool heads;
a lower cross beam extending below and transverse to the web, said lower beam supporting a lower track carrying a second line of tool heads in operative alignment with said first line of tool heads; and,
each of said cross beams defining with the respective tracks an open passage for carrying fluid pressure supply lines to the tool heads and engine mounted thereon.

38. The apparatus as set forth in claim 1 including means for locking each tool head in the operative position.

39. The apparatus as set forth in claim 38 wherein said locking means comprises a piston mounted for reciprocal movement on a line transverse to the track and operative to lock the tool head to the track.

40. The apparatus as set forth in claim 39 wherein the piston comprises said coupling operator.

41. The apparatus as set forth in claim 38 wherein said locking device comprises a common locking means for simultaneously locking all tool heads in respective operative positions.

42. The apparatus as set forth in claim 38 wherein said locking means comprises a separate locking device for each tool head operable independently of the coupling operator.
